(19) United States
(12) Patent Application Publication
(10) Pub. No.: US 2026/0180957 A1
(43) Pub. Date: Jun. 25, 2026

(54) TRANSPARENT CONTROLLER PROXY FOR ENCRYPTING TPM OR EC TRAFFIC

(71) Applicant: Hewlett-Packard Development Company, L.P., Spring, TX (US)

(72) Inventors: Christopher Ian Dalton, Bristol (GB); Adrian Laurence Shaw, Bristol (GB); Ian Alexander Pratt, Cambridge (GB); Oussama Kaddami, Bristol (GB)

(73) Assignee: Hewlett-Packard Development Company, L.P., Spring, TX (US)

(21) Appl. No.: 18/990,947

(22) Filed: Dec. 20, 2024

(51) Int. Cl. H04L 9/40

(52) U.S. Cl. CPC H04L 63/0281; H04L 63/0428

(57) ABSTRACT

Examples relate to a computing device comprising a controller to generate traffic; a trusted platform module (TPM) or embedded controller (EC); and an operating system independent firmware to capture the generated traffic, encrypt the captured traffic and transfer the encrypted traffic to the TPM or the EC.

### BACKGROUND

In a computing device, such as a notebook or desktop, bus traffic on a wire or data line between a central processing unit (CPU)/controller and a trusted platform module (TPM) may occur for several reasons, typically related to security functions. The TPM is a hardware-based security component that may provide functionalities related to authentication, system integrity, secure storage, and boot processes, but also random number generation and the like. For example, disk encryption software, such as BitLocker, may store encryption keys in a TPM and retrieves the keys from the TPM if necessary.

Likewise, there is also bus traffic between the CPU and an embedded controller (EC), for example when the Basic Input/Output System (BIOS) communicates with the EC for the purpose of coordinating hardware initialization and system management tasks. The EC is typically a controller or microcontroller integrated into a motherboard or platform of a computing device that may interact with a main CPU and operating system to perform hardware-specific tasks such as power management, thermal management, battery management and/or peripheral control.

A typical bus for the communication between the CPU and the TPM and/or the EC may be a Low Pin Count (LPC) bus, a serial peripheral interface (SPI) bus, and an Inter-Integrated Circuit (I2C) bus.

### BRIEF DESCRIPTION OF THE DRAWINGS

FIG. 1 is a diagram of an example a conventional communication between a CPU system on a chip and a separated TPM.

FIG. 2 is a diagram of an example computing device including an example controller and an example TPM according to the present disclosure.

FIG. 3 illustrates an example method for establishing an encrypted channel for TPM traffic according to the present disclosure.

FIG. 4 is a diagram of another example computing device including an example controller and an example TPM proxy according to the present disclosure.

FIG. 5 is a diagram of another example computing device including an example Central Processing Unit (CPU) subsystem, a non-volatile memory, and a controller according to the present disclosure.

FIG. 6 is a diagram of another example computing device including an example CPU subsystem, a non-volatile memory, and a (embedded) controller according to the present disclosure.

FIG. 7 is a diagram of an example system according to the present disclosure.

### DETAILED DESCRIPTION

The present disclosure relates to blocking eavesdropping on bus communication between a CPU system and the TPM and/or EC in a computing device. The computing device may be an electronic device such as a personal computer (for example a laptop, a notebook, a desktop), a mobile device (for example a smartphone, a tablet, a robot, a drone), a wearable device (such as a smart watch, a fitness tracker), a gaming console, an IoT device (for example a smart home device, a printer), a virtual and augmented reality device (for example a VR headset, AR glasses) or the like. The computing device may also be provided in vehicle.

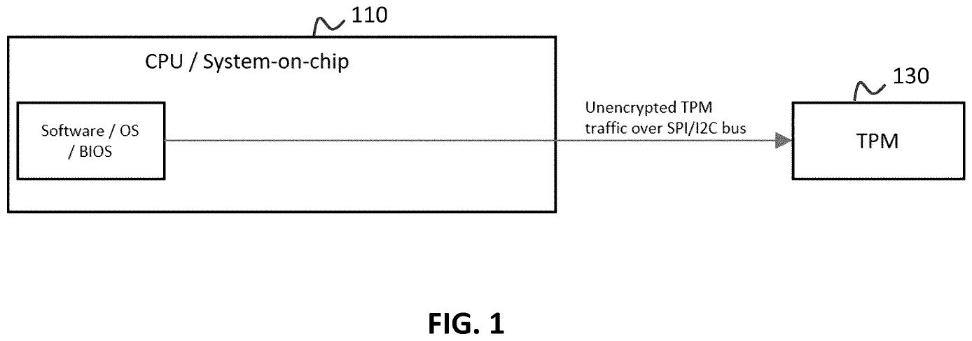

FIG. 1 shows an example of a conventional communication between a CPU system 110 on a chip and a separated TPM 130 indicating that traffic (data, commands, settings) related to or originating from the BIOS, the Operating System (OS), or related to other software is transmitted to the TPM 130 as unencrypted TPM traffic over a bus (e.g., a SPI or I2C bus). The present disclosure addresses security issues related to the observation that the bus between the CPU and the TPM and/or EC may be physically eavesdropped by an attacker. Setting PIN numbers on the TPM for mitigating such a security risk to block unattended access is, however, facing poor user and administrator experience. An attacker may also attempt to change the value of a TPM register (for example, related to hash values or measurements related to a state of the CPU system, or verification of the integrity of the CPU system) by dropping or inserting data packets onto the bus to escalate privileges, e.g., to gain higher level of access or control in a computer system. It is also noted that an attacker may de-solder and steal a TPM and/or EC from a secure platform and use it on another platform which may be possible because the TPM/EC does not have a strong binding with the platform it was installed on.

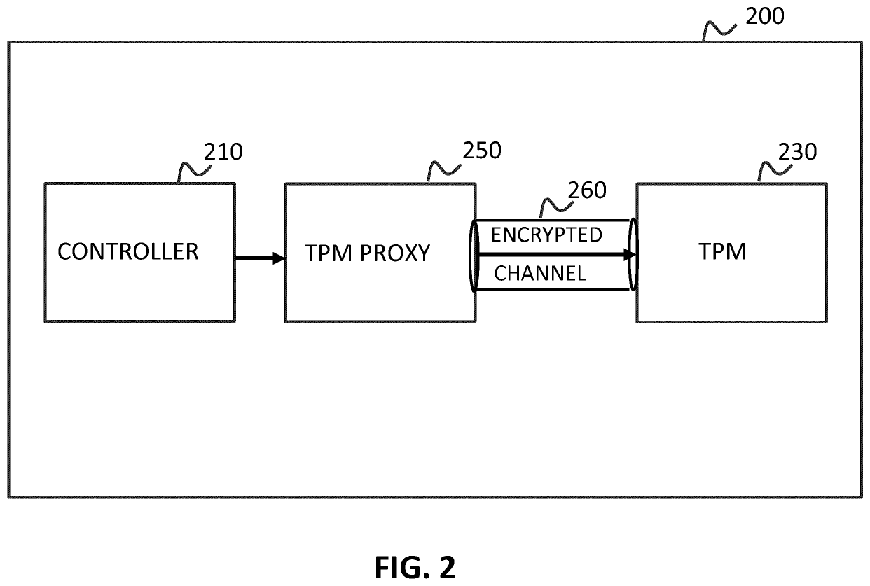

FIG. 2 is a diagram of an example computing device 200 including an example controller 210 and an example TPM 230 according to the present disclosure. The controller 210 may be (or be associated with) a CPU, a GPU, a processing chip and may be implemented on a motherboard of the computing device 200. The controller 210 may be part of a subsystem that may also include a RAM, ROM and/or One-Time Programmable (OTP) memory. As illustrated, the computing device 200 may also include operating system independent firmware 250, also referred to as TPM proxy in the following. As further illustrated in FIG. 2, an encrypted channel 260 may be established between the operating system independent firmware 250 and the TPM 230.

The TPM 230 may be a dedicated separate controller or built in TPM chip to enhance hardware security by providing secure generation, storage, and management of cryptographic keys. The TPM 230 may confirm to the standard ISO/IEC 11889. The TPM 230 may enable secure boot processes, may verify platform or disk integrity, and may protect sensitive data from unauthorized access and tampering. The TPM 230 may have one or more registers, such as the platform configuration register (PCR) to store hash values representing a state of the platform (e.g., regarding BIOS, bootloader, operating system). By storing cryptographic hashes of the boot components in the PCR, for example, the TPM 230 may determine if the computer architecture/system of the computing device had been tampered or altered with. If any component of the computer device changes, the hash value would differ from what is expected which may indicate a potential security risk.

The operating system independent firmware 250, or TPM proxy, may be considered as dedicated firmware which is independent from BIOS and is also independent from a specific operating system (such as macOS, Linux) in the sense that a change or update of the operating system of the computer device does not require a change of the TPM proxy 250. Therefore, the skilled person understands that the TPM proxy may also be considered as a transparent TPM proxy as the TPM proxy is unrelated to the specific (version of the) software operating system. The TPM proxy 250 may be embedded in a separate hardware entity, configured to control its functions independently from the system's main firmware (such as BIOS) or operating system. In particular, a controller subsystem including the operating system independent firmware 250 may be considered as the TPM proxy below. The operating system independent firmware 250 in the controller subsystem may be loaded before the controller (e.g., the main CPU) application core begins execution.

The controller 210 is to generate traffic, that is data, commands and/or settings to be transferred to the TPM 230. As illustrated in FIG. 2, the traffic may be transferred or transmitted to the TPM proxy 250 that captures the generated traffic, encrypts the captured traffic, and transfers the encrypted traffic to the TPM 230. As illustrated in FIG. 2, the TPM traffic thus occurs over an encrypted channel 260 between the TPM proxy 250 and the TPM 230. The skilled person understands that the TPM proxy 250 acts as an intermediate firmware gateway between the traffic source 210 (which may be software based, OS based, BIOS based) and the TPM 230 for the purpose of establishing an encrypted channel 260 to the TPM 230.

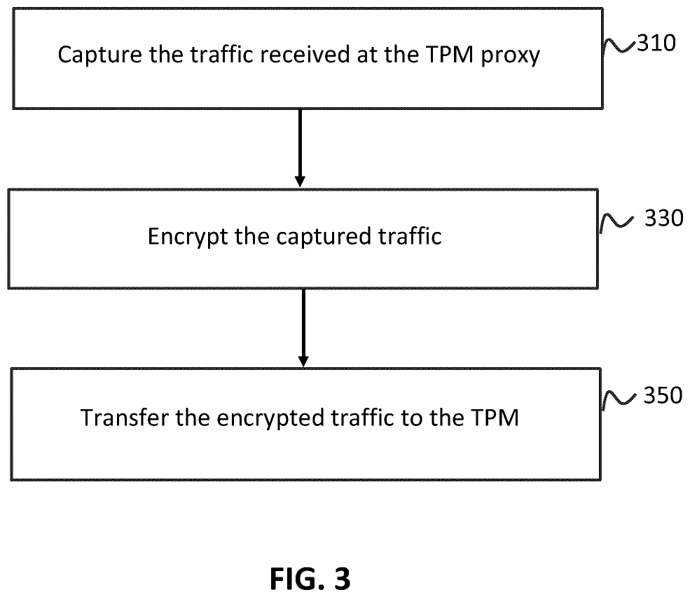

FIG. 3 illustrates an example method for establishing an encrypted channel for TPM traffic according to the present disclosure. In particular, FIG. 3 includes the act 310 to capture the traffic received at the TPM proxy 250, the act 330 to encrypt the captured traffic and the act 350 to transfer the encrypted traffic to the TPM 230. The example method may be a computer-implemented method. In particular, act 310 in FIG. 3 may be part of a sequence of individual steps, at the TPM proxy, to capture Input/Output (I/O) traffic from the controller 210, i.e. transparently (independent of OS) capturing traffic (which may be data, commands and/or settings) that may originate inside or outside of the controller 210. Further act 330 may be another step to encrypt the I/O traffic using an authentication encryption, such as Advanced Encryption Standard-Galois/Counter Mode (AES-GCM) or the like. And further, act 350 may be a step to relay the encrypted traffic to the TPM 230.

The skilled person understands that it is not the software or the OS that encrypts the TPM traffic, but the TPM firmware 250 which thus allows for transparent (OS-independent) encryption. This provides an improved security feature for the bus between the controller 210 and the TPM 230 so that, for example, an unencrypted TPM command from the OS or from BIOS or from another hardware entity is securely transmitted in an encrypted form over the bus or wire to the TPM 230. This improved security feature can be provided independent of OS or application software requirements or BIOS changes, or without requiring customers to enter a PIN during a boot sequence.

Moreover, compared to having an encrypted channel directly between the host CPU and the TPM, establishing an encrypted channel between the proxy TPM and the TPM enables to protect first measurements performed by the CPU (e.g. root of trust for measurement) before the OS is loaded. The TPM supports a mechanism referred to as the HASH_SEQUENCE, also known as Hardware Core Root of Trust Measurement (H-CRTM), that can be used to reset some components of the TPM to a known good state and enables the hardware root of trust for measurement to report the measurements to the TPM. While in conventional solutions, as illustrated in FIG. 1, these operations cannot be protected by an encrypted channel and are vulnerable to a bus interposing attack, the TPM proxy solution described in the present disclosure enables to monitor these measurements and enforce their integrity, which the host CPU is not in a position to perform.

The selected authentication encryption should provide sufficient confidentiality and integrity and may also be nonce-based (such as in AES-GCM) to provide a freshness of commands; that is, a unique nonce may be required for each encryption of the I/O traffic so that commands are not reused later. In other words, the encrypted traffic may include one-time commands, that is, commands not usable a plurality of times.

It is emphasized that the present disclosure differs from one in which a firmware TPM is implemented within a controller (e.g., CPU) subsystem and a hardware/software mechanism is provided to route TPM traffic to the firmware TPM. Such a configuration with a firmware TPM may not be robust enough against attacks and cannot reach a high enough Common Criterial security evaluation (based on, for example, ISO/IEC 15408) that customers may demand. Instead of building a firmware TPM, the present disclosure teaches to implement a TPM proxy for use in a controller subsystem to transparently capture the TPM I/O traffic, encrypt it and then relay it to an external TPM built in the computing device. This mechanism protects against attackers who eavesdrop on the bus between the controller and the TPM. This mechanism also addresses the de-solder problem described above, as a de-soldered TPM cannot be used on another platform because the I/O traffic cannot be decrypted due to key mismatch, for example.

According to a preferred example, a cryptographic key has been provisioned to the operating system independent firmware 250 and the TPM 230 during manufacture of the computing device 200. In other words, the operating system independent firmware 250 and the TPM 230 in the computing device have a shared cryptographic key; the shared cryptographic key is a key pre-installed during manufacture and is provisioned at the operating system independent firmware 250 and the TPM 230 before a user receives the computing device. The pre-installed or pre-shared key provides a lifetime pairing of the operating system independent firmware 250 and the TPM 230. That is, if one of the operating system independent firmware 250 or the TPM 230 fails or is removed, then both should be replaced.

The cryptographic key may be used to encrypt the captured traffic at the operating system independent firmware 250 and to decrypt the encrypted traffic at the TPM 230. For example, a cryptographic symmetric key, e.g., associated with AES-GCM and having a predefined key size, may be provisioned both in the operating system independent firmware 250 and the TPM 230. The TPM 230 may use the decrypted traffic in relation to at least one of authentication, system integrity, secure storage, boot process, and random number generation. This allows both the TPM proxy 250 and the TPM 230 to securely communicate with each other. The secure communication may, for example, also use a protocol such as Security Protocol Data Model (SPDM) or the like with a pre-shared key. The pre-shared key may be used for authentication and setting up a secure communication channel 260 between the TPM proxy 250 and the TPM 230.

According to another preferred example, the operating system independent firmware 250 is to generate a cryptographic channel to the TPM 230. The cryptographic channel may be generated using a protocol such as SPDM or the like using a key pre-shared between the operating system independent firmware 250 and the TPM 230. As explained, the key may be pre-shared during manufacture of the computing device and may be used to authenticate the operating system independent firmware 250 and the TPM 230. The captured traffic may then be encrypted using the cryptographic symmetric key (such as AES-GCM) and may also be supplemented using signatures or the like to be able to evaluate the integrity of the traffic. In addition, a bus specific communication protocol, such as I2C or SPI, may be used to transfer the TPM traffic over the encrypted channel 260. In other words, using a pre-shared key, the TPM proxy 250 may run a dedicated firmware to create a cryptographic channel 260 with the TPM 230.

According to another preferred example, the operating system independent firmware 250 may further instruct the TPM 230 to maintain an encryption protocol and/or to maintain the cryptographic channel 260. For example, the operating system independent firmware 250 may instruct the TPM 230 to deny downgrade of the communication protocol. In other words, the operating system independent firmware 250 may instruct the TPM 230 to ensure the TPM to only accept secure communication protocols of a specific secure version and to block a fallback to weaker versions, in particular to disable unencrypted communication channel. The operating system independent firmware 250 may also instruct the TPM 230 to block unencrypted traffic and to regularly verify the encryption settings to continuously block tampering. This may be achieved by the TPM proxy 250 setting flags in the TPM 230, by transmitting respective configuration settings to the TPM 230, preferably also over the encrypted channel 260.

According to another preferred example, the controller 210 of the computing device 200 is to redirect the traffic to the operating system independent firmware 250. Here, the controller 210 may be provided with a build-in mechanism to redirect traffic to the TPM, which may also be referred to as TPM requests, to the operating system independent firmware 250; that is, the controller 210 may direct traffic to a subsystem (such as a CPU vendor subsystem) that may contain a software implementation of firmware, or to an external SPI controller. The controller 210 may thus be configured to send the TPM traffic to the operating system independent firmware 250 which may run on the controller subsystem, and the operating system independent firmware 250 may then transfer or pass the TPM traffic into the established cryptographic channel. An external SPI controller may not be involved with the TPM proxy 250.

According to another preferred example, the controller 210 of the computing device 200 has a status register and the operating system independent firmware 250 is to use the status register to control a flow of the encrypted traffic to the TPM 230. Here, the status register may register flags, such as a busy flag, an error flag, a READY flag, and the like to indicate an internal state, operations and/or settings of the TPM 230. In particular, the status register may be used to monitor and/or control a status of the TPM 230, in particular for the purpose of synchronizing commands between the controller and the TPM. For example, the status register in the controller 200 or in the controller subsystem may indicate, for example to the OS and/or BIOS, that the TPM 230 is busy processing a command and that subsequent requests to the TPM 230 should wait before being transferred to the TPM 230, as they otherwise may be rejected.

According to the present disclosure, the operating system independent firmware 250 may use this status register to perform a flow control to avoid that more than a specific number of TPM requests are issued from the controller 210. The specific number of TPM requests used for the flow control may be a predetermined number or may be adapted in view of workflow or load conditions and the like. Here, the operating system independent firmware 250 may set a bit (such as a READY bit) or flag in the status register to allow or to prohibit TPM traffic to be sent via the encrypted channel to the TPM 230.

According to another example, a status register may also be provided in the operating system independent firmware 250. Here, when the TPM proxy 250 receives TPM traffic or a TPM request, the TPM traffic/request may be intercepted and temporarily stored, for example in a First in, First Out (FIFO)-type memory structure, for example to allow for buffering of a sufficient amount of data in a queue for efficient encryption. The TPM proxy 250 may then set an associated READY bit in the status register to allows the encrypted traffic to be sent. Alternatively, the status register may also be used to bypass prioritized TPM traffic, that is TPM commands that require fast response times from the TPM.

According to another preferred example, the operating system independent firmware 250 may further detect unusual or unexpected commands in the TPM traffic, for example commands coming from software rather than BIOS, as expected. Here, the operating system independent firmware 250 may employ a strategy to monitor, analyze, and/or validate commands as they are received (having been redirected from the controller 210 to the TPM proxy 250). For example, a whitelist of allowed commands may be predefined so that commands that do not match this list are considered unusual or unexpected commands and are thus rejected or logged. Here, the operating system independent firmware 250 may also perform a syntax checking to verify whether the TPM commands follow an expected format, and/or may verify whether corresponding parameter values of the TPM commands are within a valid range and type. The operating system independent firmware 250 may also analyze time intervals between TPM commands to determine whether such TPM commands are sent too quickly or at irregular intervals. Such commands may be flagged as suspicious and rejected or logged. The operating system independent firmware 250 may also detect if an interposer (attacker) tries to change a TPM state, such as the current privilege (which may also be referred to as “locality”). The TPM 230 may enable the host to configure such a state by manipulating a register, such as the ACCESS register. While such configuration commands may not be authenticated, the proposed solution binds a relevant TPM state in additional authenticated data (ADD) of the authenticated encryption scheme, i.e. data used by an attestation authority to verify an identity and state of a device, of the commands sent over the encrypted channel so that any tampering would be detectable.

The TPM 230 may further reject any traffic that has bypassed the TPM proxy 250. That is, the TPM 230 may reject traffic that, intentionally or unintentionally, has been directly communicated to the TPM 230, for example via a bus different from the bus between the proxy TPM 250 and the TPM 230. The TPM 230 may thus reject bypassed traffic because it is not encrypted with the cryptographic key used in a communication session with the TPM 230.

According to another preferred example, if there is an option to turn off the encrypted channel 260, for example via a setting in the BIOS menu or the like, then, when the encrypted channel is deactivated, the TPM 230 itself may perform a TPM clear operation to delete user data inside the TPM.

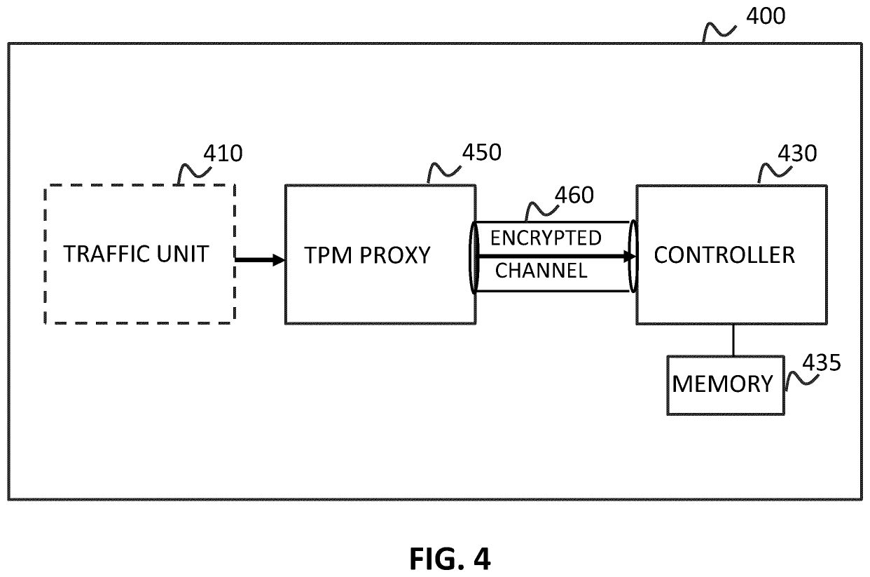

FIG. 4 is a diagram of another example computing device 400 including an example controller 430, a non-volatile memory 435, an example TPM proxy 450 according to the present disclosure. The controller 430 may be a controller of a TPM, as described above. The TPM proxy 450 is an operating system independent (transparent) firmware, as described above, and may be configured to capture data traffic originating or otherwise transferred from a software application, the operating system of the computing device, or the BIOS of the computing device, generally referred to as Software/OS/BIOS traffic unit 410 (which may be another controller or system of controllers, e.g., the controller 210 shown above). The non-volatile memory 435 may be a flash memory, a read-only memory (ROM) or the like to store a cryptographic key. As described, the cryptographic key may be a cryptographic symmetric key that is pre-shared with the TPM proxy 450, for example provisioned during manufacturing of the computing device in both the non-volatile memory 435 and the TPM proxy 450.

The controller 430 may use the cryptographic key to establish an encrypted channel 460 with the TPM proxy 450. As such, traffic originating from the Software/OS/BIOS traffic unit 410 and directed to the TPM proxy 450 may be securely transmitted to the controller 430 of the TPM. Therefore, TPM proxy 450 and the controller 430 of the TPM can securely communicate with each other to securely transfer traffic from Software/OS/BIOS, for example using a predetermined protocol, such as SPDM or the like, with the stored cryptographic key.

The controller 430 may reject any traffic or command having bypassed the TPM proxy 450, that is the controller 430 may reject any traffic or command received at the controller 430 that has been communicated on a bus or channel that differs from the established encrypted channel. Here, the controller 430 may simply drop such bypassed traffic, may log information regarding the bypassed traffic for further analysis of TPM security, or may issue a warning message, for example to the BIOS of the computing device.

The TPM proxy 450 may further implement the functionalities as described above for the TPM proxy 250. For example, the controller 430 may maintain the cryptographic channel upon receiving an instruction from the TPM proxy 450. The controller 430 may also maintain an encryption protocol upon receiving an instruction from the TPM proxy 450. As described, the TPM proxy 450 may instruct the controller 430 to deny downgrade of the communication protocol, that is to ensure the controller 430 of the TPM to only accept secure communication protocols of a specific secure version and to block a fallback to weaker versions, in particular to disable unencrypted communication channel. The TPM proxy 450 may also instruct the controller 430 of the TPM to block unencrypted traffic and to regularly verify the encryption settings to continuously block tampering. This may be achieved by the TPM proxy 450 setting flags in the controller 430 of the TPM, by transmitting respective configuration settings to the controller 430 of the TPM, preferably also over the encrypted channel 460.

The controller 430 of the TPM may also receive nonce-based encrypted traffic, for example one-time commands as example of encrypted traffic usable only a single time to provide a freshness of commands.

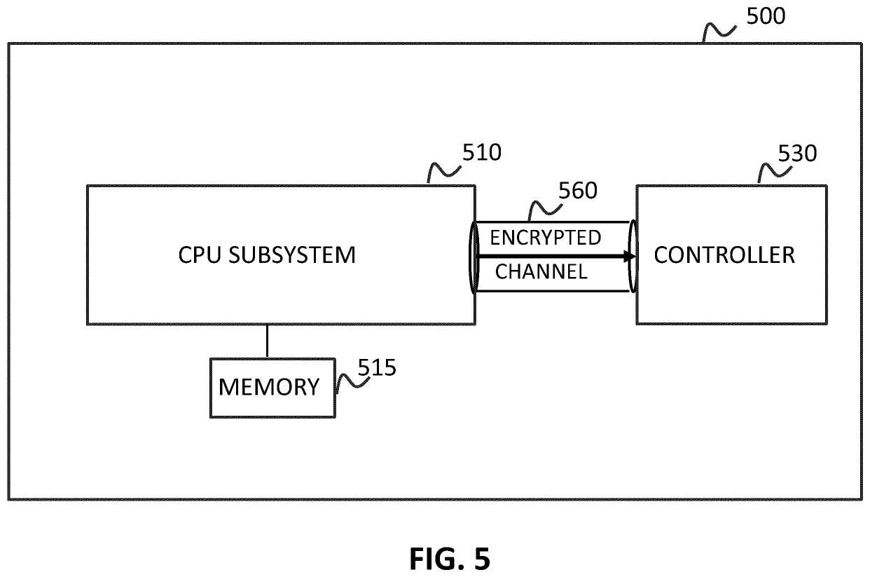

FIG. 5 is a diagram of another example computing device 500 including an example Central Processing Unit (CPU) subsystem 510, a non-volatile memory 515, and a controller 530 according to the present disclosure. The controller 530 may be an embedded controller (EC). Here, the non-volatile memory 515, which may also be part of the CPU subsystem, may store a pre-shared key: the pre-shared key may be a cryptographic symmetric key that is shared between the CPU subsystem 510 and the controller 530, for example provided when manufacturing the computing device. The CPU subsystem 510 may include a CPU, a microcontroller, a system on a chip or the like and may also include Basic Input/Output System (BIOS) and additional firmware.

The controller 530 may communicate with the CPU subsystem 510 to receive BIOS commands and/or other system commands, whereby such commands are being encrypted using the pre-shared key. The CPU subsystem 510, for example by employing specific firmware, may thus be setup to receive commands from the BIOS that are heading to the (embedded) controller 530, encrypt the commands automatically with the pre-shared key that both the CPU subsystem 510 and the (embedded) controller 530 have. The traffic to the (embedded) controller 530 is thus communicated over an established encrypted channel 560. This mechanism provides mutual authentication between the CPU subsystem 510 and the (embedded) controller 530 and addresses disadvantages of conventional solutions in which the BIOS communicates with the (embedded) controller 530 over an insecure physical link (such as via an (enhanced) SPI interface or I2C interface) which does not provide mutual authentication between BIOS and the (embedded) controller and allows for a physical attacker to perform man-in-the-middle communications.

The commands may, for example, be received at the controller 530 from the BIOS in System Management Mode (SMM) for the CPU of x86 architecture or the like, that is, when handling system-wide functions such as power management, hardware control, and system security. Such SMM commands may be used independent from the standard operating system environment and may be triggered by CPU system events, such as System Management Interrupts directing the CPU into this mode.

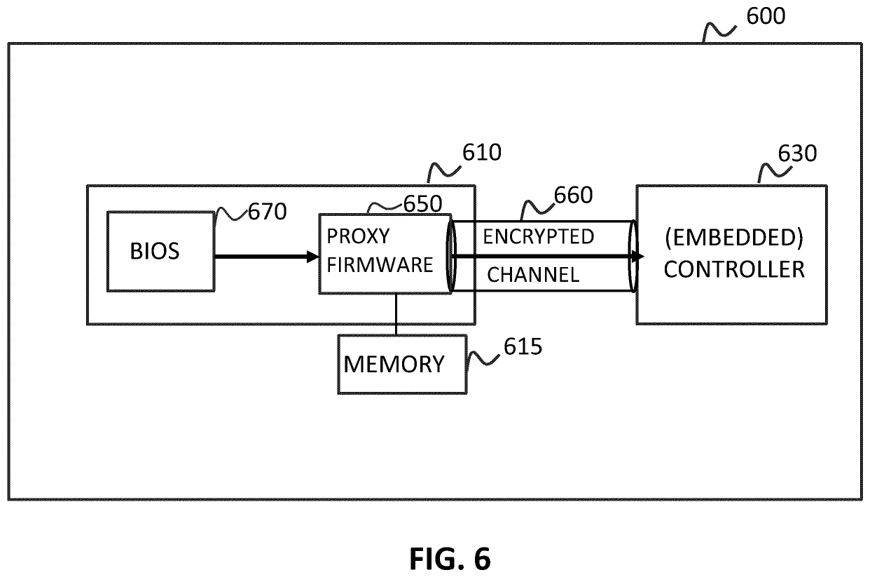

FIG. 6 is a diagram of another example computing device 600 including an example Central Processing Unit (CPU) subsystem 610, a non-volatile memory 615, and a (embedded) controller 630 according to the present disclosure. The CPU subsystem 610 may include BIOS 670 of the computing device 600 and an OS independent firmware 650 which may also be referred to as proxy firmware for the (embedded) controller (EC proxy firmware). The OS independent firmware 650 may thus receive BIOS commands redirected from BIOS 670, encrypt the redirected BIOS commands with the cryptographic key pre-shared, stored in the non-volatile memory 615, and transfer the encrypted traffic to the (embedded) controller 630. As such a transparent (OS independent) CPU proxy can be provided for encrypting BIOS traffic to the (embedded) controller 630. The communication of the BIOS commands (or other commands) between CPU subsystem 610 to the (embedded) controller 630 is thus communicated over an encrypted channel 660 generated between the OS independent firmware 650 and the (embedded) controller 630, as explained above.

The CPU proxy 650 may further implement the functionalities as described above for the TPM proxy 250.

According to another preferred example, the established encrypted channel between the CPU subsystem or (embedded) controller proxy firmware, respectively, to the (embedded) controller 630 is de-activatable. A de-activation of the encrypted channel may be achieved in a plurality of ways, for example via a setting in the proxy firmware or via a setting at the BIOS which may instruct the proxy firmware to deactivate the encrypted channel. Alternatively, encryption libraries, registers, or flags may be set to enable and disable encryption. This allows to add and deactivate an encrypted channel as an extra security layer to CPU-controller protocol such as I2C, SPI, or the like.

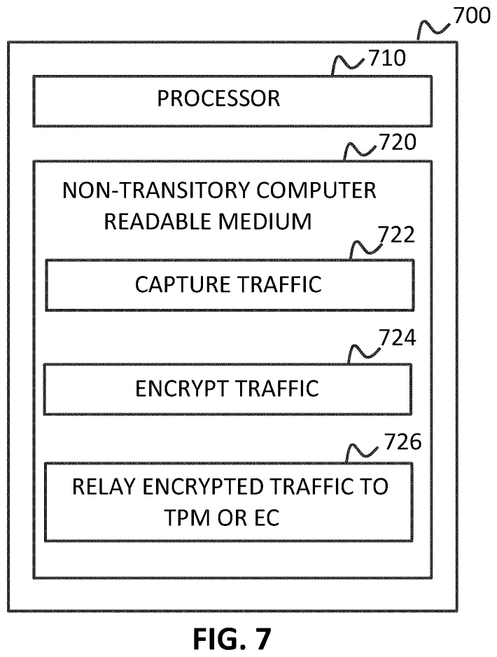

FIG. 7 is a diagram of an example system 700 according to the present disclosure. The system may include a processor 710 and a non-transitory computer-readable storage medium 720 to store a computer program. Although the description may refer to a single processor and a single computer-readable storage medium, the description may also apply to a system with multiple processors and multiple computer-readable storage mediums. In such an example, the instructions may be distributed and stored across multiple computer-readable storage mediums and the instructions may be distributed and executed across multiple processors.

Processor 710 may be a CPU, a semiconductor-based microprocessor, and/or a hardware device suitable for retrieval and execution of instructions stored in the computer-readable storage medium 720. The processor 710 may fetch, decode, and execute instructions 722, 724, 726. The processor may be a part of a controller of a computing device as described above.

Referring to FIG. 7, capture traffic instruction 722, when executed by a processor of a controller, may comprise capture the traffic received at the operating system independent firmware proxy of a TPM or EC. As explained, the traffic can be software-related traffic, OS related traffic, and/or BIOS related traffic. In addition, encrypt traffic instruction 724, when executed by the processor of the controller, may comprise encrypting the captured traffic, for example based on a pre-shared cryptographic symmetric key. In addition, transfer the encrypted traffic instruction 726, when executed by the processor of the controller, may comprise relaying the encrypted traffic to a TPM or a EC.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated to provide a number of additional examples of the present disclosure. In addition, the proportion and the relative scale of the elements provided in the figures are intended to illustrate the examples of the present disclosure and should not be taken in a limiting sense.

1. A computing device, comprising
a controller to generate traffic;
a trusted platform module (TPM); and
an operating system independent firmware to capture the generated traffic, encrypt the captured traffic and transfer the encrypted traffic to the TPM.

2. The computing device of claim 1, wherein a cryptographic key is provided to both the operating system independent firmware and the TPM.

3. The computing device of claim 1, wherein the operating system independent firmware is to generate a cryptographic channel to the TPM.

4. The computing device of claim 1, wherein the operating system independent firmware is to instruct the TPM to maintain an encryption protocol and/or to maintain a cryptographic channel.

5. The computing device of claim 1, wherein the controller is to redirect the traffic to the operating system independent firmware.

6. The computing device of claim 1, wherein the controller has a status register, the operating system independent firmware to use the status register to control a flow of the traffic.

7. The computing device of claim 1, wherein the controller has a status register, the operating system independent firmware to set a bit in the status register.

8. The computing device of claim 1, the operating system independent firmware further to detect unusual or unexpected commands.

9. The computing device of claim 1, wherein the encrypted traffic includes one-time commands.

10. A computing device, comprising:
a trusted platform module (TPM) proxy;
a non-volatile memory to store a cryptographic key; and
a controller to establish an encrypted channel with the TPM proxy using the cryptographic key.

11. The computing device of claim 10, the controller further to reject a command having bypassed the TPM proxy.

12. The computing device of claim 10, wherein the cryptographic key is a key pre-shared with the TPM proxy.

13. The computing device of claim 10, the controller to maintain the cryptographic channel upon receiving an instruction from the TPM proxy.

14. The computing device of claim 10, the controller to receive nonce-based encrypted traffic.

15. A computing device, comprising
a Central Processing Unit (CPU) subsystem;
a non-volatile memory to store a pre-shared key; and
a controller to communicate with the CPU subsystem and to receive Basic Input/Output System (BIOS) commands, the BIOS commands being encrypted using the pre-shared key.

16. The computing device of claim 15, the communication of the BIOS commands between the controller and the CPU subsystem to be performed over an encrypted channel.

17. The computing device of claim 16, wherein the encrypted channel is de-activatable.

18. The computing device of claim 15, wherein the CPU subsystem includes a BIOS and an Operating System (OS) independent firmware, the BIOS redirecting BIOS commands to the OS independent firmware.

19. The computing device of claim 18, the OS independent firmware to receive the BIOS commands redirected from the BIOS, encrypt the redirected BIOS commands with the pre-shared key pre-shared, and transfer the encrypted traffic to the controller.

20. The computing device of claim 18, wherein the encrypted channel is generated between the OS independent firmware and the controller.
